(19) United States
(12) Patent Application Publication
(10) Pub. No.: US 2019/0039169 A1
(43) Pub. Date: Feb. 7, 2019

(54) LASER MACHINING DEVICE AND LASER MACHINING METHOD

(71) Applicant: HAMAMATSU PHOTONICS K.K., Hamamatsu-shi, Shizuoka (JP)

(72) Inventor: Junji OKUMA, Hamamatsu-shi, Shizuoka (JP)

(73) Assignee: HAMAMATSU PHOTONICS K.K., Hamamatsu-shi, Shizuoka (JP)

(21) Appl. No.: 16/073,504

(22) PCT Filed: Jan. 23, 2017
(86) PCT No.: PCT/JP2017/002168

§ 371 Date: Jul. 27, 2018

(30) Foreign Application Priority Data
Jan. 28, 2016 (JP) 2016-014530

(51) Int. Cl. B23K 26/00; B23K 26/03; B23K 26/04; B23K 26/0622; B23K 26/08; B23K 26/53

(52) U.S. Cl. CPC B23K 26/0006; B23K 26/034; B23K 26/048; B23K 2101/40; B23K 26/0869; B23K 26/53; B23K 26/0622

(57) ABSTRACT

A laser processing apparatus that performs laser processing on an object to be processed by irradiating the object with laser light along a line to process includes a support table, a laser light source, a converging unit, a moving unit, an actuator, a displacement sensor, a temperature sensor, and a control unit. The control unit calculates the amount of driving of a converging unit that is performed by the actuator on the basis of a displacement of an incidence surface measured by the displacement sensor and a temperature of the converging unit detected by the temperature sensor, and controls the actuator such that the converging unit is driven according to the amount of driving when the moving unit relatively moves a converging point.

### TECHNICAL FIELD

One aspect of the present invention relates to a laser processing apparatus and a laser processing method.

### BACKGROUND ART

Patent Literature 1 describes a semiconductor chip manufacturing method. In this method, a semiconductor wafer formed by laminating an n-type gallium nitride-based semiconductor layer (an n-type layer) and a p-type gallium nitride-based semiconductor layer (a p-type layer) on a sapphire substrate is divided into a plurality of semiconductor chips. In this method, first, an element isolation trench is formed according to a desired chip shape. The element isolation trench is formed by etching the p-type layer. Subsequently, a modified region is formed inside the sapphire substrate. The modified region is formed by irradiating the inside of the sapphire substrate with a laser light with an aligned converging point. The modified region is used for division of the semiconductor wafer.

### CITATION LIST

### Patent Literature

[Patent Literature 1] Japanese Unexamined Patent Publication No. 2011-181909

### SUMMARY OF INVENTION

### Technical Problem

In the above method, the modified region is formed to be shifted from a center line of the element isolation trench in consideration for the tendency for a fracture surface to be obliquely formed due to the properties of a gallium nitride-based compound semiconductor. Accordingly, the fracture surface appears in the element isolation trench. Thus, in the technical field, a formation position of the modified region is controlled according to a direction along an incidence surface of the laser light.

Incidentally, it is desirable to accurately control the formation position of the modified region also in a thickness direction of an object to be processed (that is, a direction crossing the incidence surface of the laser light). Therefore, it is required to accurately control a converging position of the laser light according to a displacement of an incidence surface in a direction crossing the incidence surface of the laser light. This is similarly required in the case of laser processing (for example, surface processing such as ablation) other than formation of the modified region.

In order to control the converging position of the laser light according to the displacement of the incidence surface, for example, irradiation with laser light performed while measuring the displacement of the incidence surface of the laser light using a displacement sensor and adjusting the converging position of the laser light on the basis of the displacement may be conceived. In order to adjust the converging position of the laser light, a converging unit including a converging lens for converging the laser light may be driven according to the displacement of the incidence surface by, for example, an actuator or the like.

However, the temperature of the converging unit may vary according to the energy of the laser light. When the temperature of the converging unit varies, a focal position of the converging lens also varies. Therefore, even when the converging unit is driven on the basis of the displacement of the incidence surface measured by the displacement sensor, there is concern that the converging position of the laser light may be shifted from a desired position. In this case, the accuracy of the laser processing deteriorates.

Therefore, an object of aspects of the present invention is to provide a laser processing apparatus and a laser processing method in which deterioration in accuracy of laser processing is able to be curbed.

### Solution to Problem

A laser processing apparatus according to an aspect of the present invention is a laser processing apparatus that performs laser processing on an object to be processed by irradiating the object with laser light along a line to process, and includes a support table that supports the object; a laser light source that outputs the laser light; a converging unit including a converging lens for converging the laser light on the object supported by the support table; a moving unit that moves at least one of the support table and the converging unit along an incidence surface of the laser light in the object and relatively moves a converging point of the laser light along the line to process; an actuator for driving the converging unit in a direction crossing the incidence surface; a displacement sensor that measures a displacement of the incidence surface along the line to process; a temperature sensor that detects a temperature of the converging unit; and a control unit that calculates the amount of driving of the converging unit by the actuator on the basis of the displacement of the incidence surface measured by the displacement sensor and the temperature of the converging unit detected by the temperature sensor, and controls the actuator such that the converging unit is driven according to the amount of driving when the moving unit relatively moves the converging point.

A laser processing method according to an aspect of the present invention is a laser processing method for performing laser processing on an object to be processed by irradiating the object with laser light along a line to process, and includes: a temperature detection step of detecting a temperature of a converging unit including a converging lens for converging the laser light on the object; a displacement measurement step of measuring a displacement of an incidence surface of the laser light in the object along the line to process; a calculation step of calculating the amount of driving of the converging unit in a direction crossing the incidence surface, on the basis of a displacement of the incidence surface measured in the displacement measurement step and the temperature of the converging unit detected in the temperature detection step; and a processing step of performing the laser processing by irradiating the object with the laser light while driving the converging unit according to the amount of driving and while relatively moving the converging point of the laser light along the line to process.

In the laser processing apparatus and the laser processing method, the position of the converging point of the laser light with respect to the incidence surface can be adjusted by driving the converging unit in the direction crossing the incidence surface of the laser light. In particular, in the laser processing apparatus and the laser processing method, the displacement of the incidence surface is measured and the temperature of the converging unit is measured. The amount of driving of the converging unit is calculated on the basis of both the displacement of the incidence surface and the temperature of the converging unit. In addition, when the converging point of the laser light is relatively moved (that is, when the laser light is radiated), the converging unit is driven according to the amount of driving. Therefore, in the laser processing apparatus and the laser processing method, it is possible to adjust the position of the converging point of the laser light with respect to the incidence surface in consideration of the temperature of the converging unit. That is, the position of the converging point of the laser light can be accurately controlled regardless of the temperature of the converging unit. Accordingly, deterioration in accuracy of laser processing is curbed. It should be noted that the incidence surface of the laser light means a surface on which the laser light is incident in the object.

In the laser processing apparatus according to an aspect of the present invention, the control unit may include a data holding unit that holds amount-of-variation data indicating a relationship between a temperature of the converging unit and the amount of variation in a focal position of the converging lens; a correction unit that acquires the amount of variation in the focal position according to the temperature of the converging unit detected by the temperature sensor by referring to the amount-of-variation data, and corrects the displacement of the incidence surface measured by the displacement sensor on the basis of the amount of variation to thereby calculate the amount of driving; and a driving control unit that controls the actuator such that the converging unit is driven according to the amount of driving. In this case, calculation of the amount of driving is facilitated.

In the laser processing apparatus according to an aspect of the present invention, the displacement sensor may measure the displacement of the incidence surface by making the measurement light be incident on the incidence surface in an optical path different from an optical path of the laser light and detecting reflected light of the measurement light. Thus, when the optical path of the laser light is different from the optical path of the measurement light of the displacement sensor, an irradiation state of the measurement light is independent of a variation in the focal position of the converging lens due to change in the temperature of the converging unit. Therefore, it is particularly important to adjust the position of the converging point of the laser light in consideration of the temperature of the converging unit, as described above.

In the laser processing apparatus according to an aspect of the present invention, the converging unit may include a housing that holds the converging lens, and the temperature sensor may be attached to the housing and detect a temperature of the housing as a temperature of the converging unit. The variation in the focal position of the converging lens greatly depends on change in the temperature of the housing holding the converging lens. Therefore, the position of the converging point of the laser light can be controlled more accurately by detecting the temperature of the housing and using the temperature for calculation of the amount of driving.

In the laser processing apparatus according to an aspect of the present invention, the converging unit may include a housing that holds the converging lens, the actuator may be connected to the housing, and the temperature sensor may be attached to the actuator and detect a temperature of the actuator as a temperature of the converging unit. In this case, as in the above case, the position of the converging point of the laser light can be controlled more accurately by detecting the temperature of the actuator connected to the housing and using the temperature for calculation of the amount of driving. In particular, in this case, there is no problem of layering of wirings of the temperature sensor when the converging unit is handled (for example, detached).

A laser processing apparatus according to an aspect of the present invention is a laser processing apparatus that performs laser processing on an object to be processed by irradiating the object with laser light along a line to process, and includes a support table that supports the object; a laser light source that outputs the laser light; a converging unit including a converging lens for converging the laser light on the object supported by the support table; a moving unit that moves at least one of the support table and the converging unit along an incidence surface of the laser light in the object and relatively moves a converging point of the laser light along the line to process; an adjustment unit that adjusts a position of the converging point in a direction crossing the incidence surface; a displacement sensor that measures a displacement of the incidence surface along the line to process; a temperature sensor that detects a temperature of the converging unit; and a control unit that calculates the amount of adjustment in the adjustment unit on the basis of the displacement of the incidence surface measured by the displacement sensor and the temperature of the converging unit detected by the temperature sensor, and controls the adjustment unit such that the adjustment unit adjusts the position of the converging point according to the amount of adjustment when the moving unit relatively moves the converging point.

A laser processing method according to an aspect of the present invention is a laser processing method for performing laser processing on an object by irradiating the object with laser light along a line to process, and includes a temperature detection step of detecting a temperature of a converging unit including a converging lens for converging the laser light on the object; a displacement measurement step of measuring a displacement of an incidence surface of the laser light in the object along the line to process; a calculation step of calculating the amount of adjustment of a position of a converging point of the laser light in a direction crossing the incidence surface, on the basis of a displacement of the incidence surface measured in the displacement measurement step and the temperature of the converging unit detected in the temperature detection step; and a processing step of performing the laser processing by irradiating the object with the laser light while adjusting the position of the converging point according to the amount of adjustment and while relatively moving the converging point along the line to process.

In the laser processing apparatus and the laser processing method, the position of the converging point of the laser light with respect to the incidence surface can be adjusted in the direction crossing the incidence surface of the laser light. In particular, in the laser processing apparatus and the laser processing method, the displacement of the incidence surface is measured and the temperature of the converging unit is measured. The amount of adjustment of the converging point is calculated on the basis of both the displacement of the incidence surface and the temperature of the converging unit. In addition, when the converging point of the laser light is relatively moved (that is, when the laser light is radiated), the converging point is adjusted according to the amount of adjustment. Therefore, in the laser processing apparatus and the laser processing method, it is possible to adjust the position of the converging point of the laser light with respect to the incidence surface in consideration of the temperature of the converging unit. That is, the position of the converging point of the laser light can be accurately controlled regardless of the temperature of the converging unit. Accordingly, degradation in accuracy of laser processing is curbed.

In the laser processing apparatus according to an aspect of the present invention, the control unit may include a data holding unit that holds amount-of-variation data indicating a relationship between a temperature of the converging unit and the amount of variation in a focal position of the converging lens; a correction unit that acquires the amount of variation in the focal position according to the temperature of the converging unit detected by the temperature sensor by referring to the amount-of-variation data, and corrects the displacement of the incidence surface measured by the displacement sensor on the basis of the amount of variation to calculate the amount of adjustment; and an adjustment control unit that controls the adjustment unit such that the converging point is adjusted according to the amount of adjustment. In this case, calculation of the amount of adjustment is facilitated.

### Advantageous Effects of Invention

According to an aspect of the present invention, it is possible to provide a laser processing apparatus and a laser processing method in which degradation in accuracy of laser processing is able to be curbed.

### BRIEF DESCRIPTION OF DRAWINGS

FIG. 1 is a schematic configuration diagram of a laser processing apparatus.

FIG. 2 is a plan view of an object to be processed that is a formation target for a modified region.

FIG. 3 is a cross-sectional view taken along line III-III of the object in FIG. 2.

FIG. 4 is a plan view of an object to be processed after laser processing.

FIG. 5 is a cross-sectional view taken along line V-V of the object in FIG. 4.

FIG. 6 is a cross-sectional view taken along line VI-VI of the object in FIG. 4.

FIG. 7 is a schematic configuration diagram of a displacement sensor.

FIG. 8 is a graph showing an example of amount-of-variation data.

FIG. 9 is a view illustrating an operation of a converging position control unit.

FIG. 10 is a view illustrating main steps of a laser processing method.

FIG. 11 is a view illustrating main steps of the laser processing method.

FIG. 12 is a diagram illustrating main steps of the laser processing method.

FIG. 13 is a diagram illustrating correction of surface displacement.

### DESCRIPTION OF EMBODIMENTS

Hereinafter, an embodiment of an aspect of the present invention will be described in detail with reference to the drawings. In each figure, the same or corresponding parts are denoted by the same reference numerals, and duplicated description will be omitted.

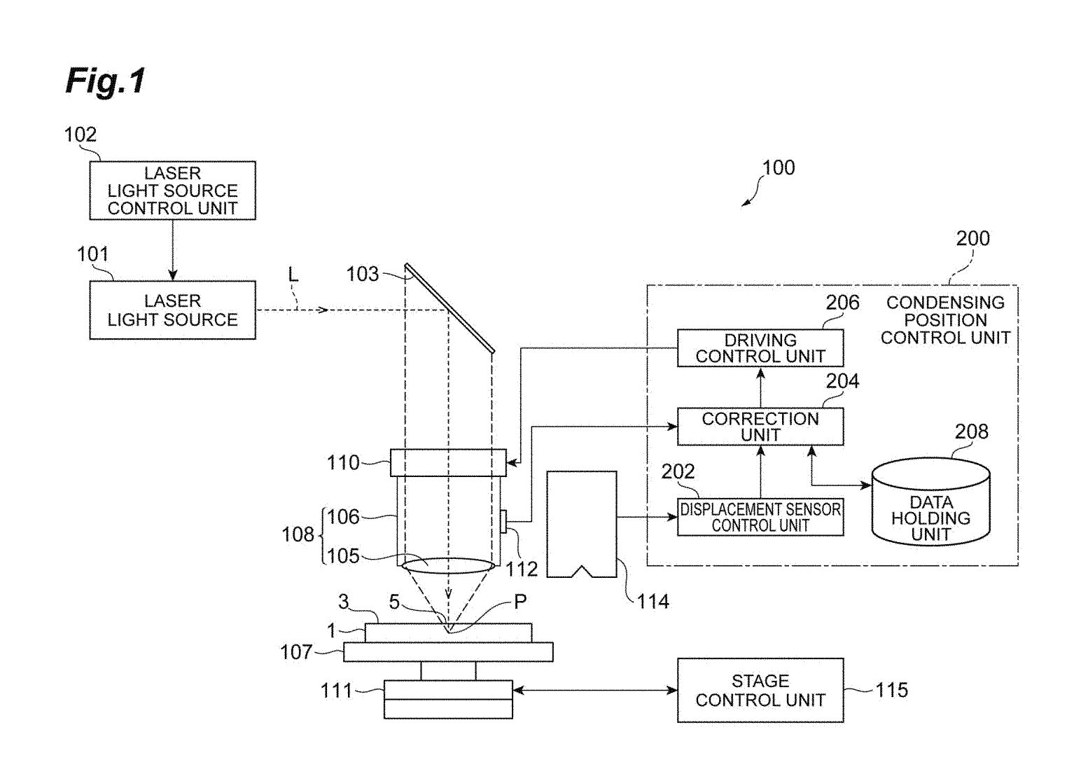

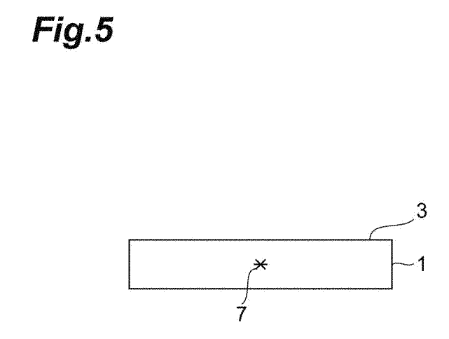

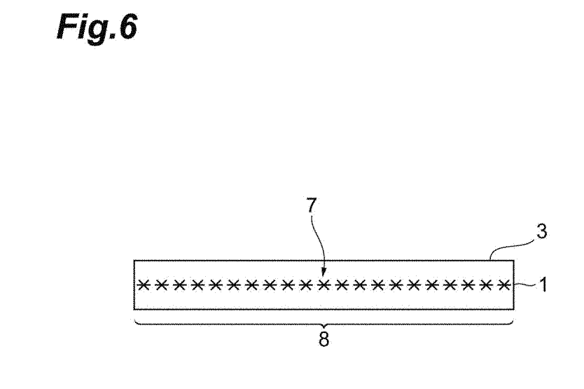

In a laser processing apparatus and a laser processing method according to the embodiment, a modified region is formed in an object to be processed along a line to cut (a line to process) by converging a laser light on an object to be processed as an example of laser processing. Therefore, first, the formation of the modified region will be described with reference to FIGS. 1 to 6.

As illustrated in FIG. 1, the laser processing apparatus 100 includes a laser light source 101 for generating laser light L as a pulse, a dichroic mirror 103 disposed so as to change a direction of an optical axis (optical path) of the laser light L by 90°, and a converging lens 105 for converging the laser light L. Further, the laser processing apparatus 100 includes a support table 107 for supporting an object to be processed 1 that is irradiated with the laser light L converged by the converging lens 105, a stage (a moving unit) 111 for moving the support table 107, a laser light source control unit 102 that controls the laser light source 101 in order to adjust an output, a pulse width, a pulse waveform, or the like of the laser light L, and a stage control unit (a moving unit) 115 that controls movement of the stage 111.

In the laser processing apparatus 100, the direction of the optical axis of the laser light L emitted from the laser light source 101 is changed by 90° by the dichroic mirror 103, and the laser light L is converged in the inside of the object 1 placed on the support table 107 by the converging lens 105. At the same time, the stage 111 is moved, and the object 1 is moved relative to the laser light L along a line to cut 5. Accordingly, the modified region is formed in the object 1 along the line to cut 5. It should be noted that, here, although the stage 111 is moved to relatively move the laser light L, the converging lens 105 may be moved or both of the stage 111 and the converging lens 105 may be moved.

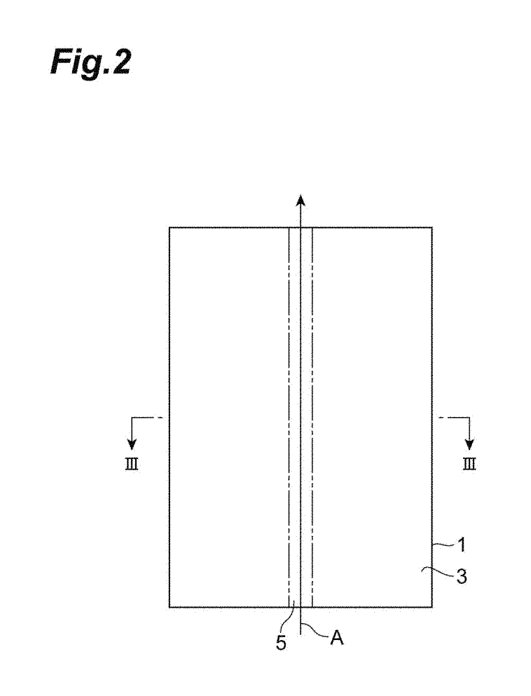

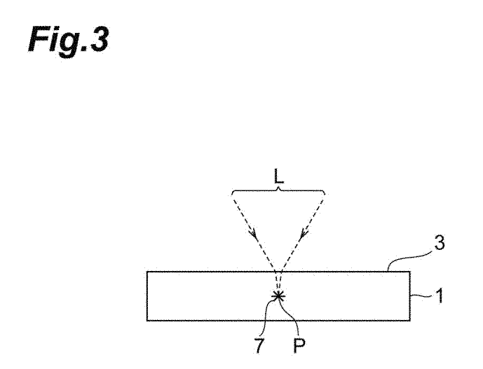

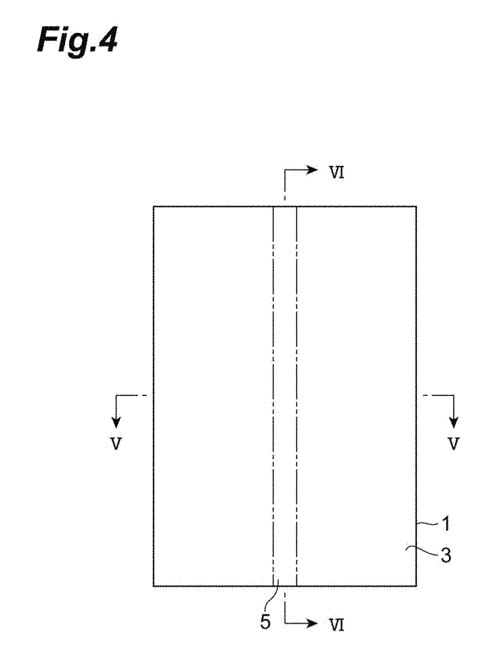

A plate-like member (for example, a substrate, a wafer, or the like) including a semiconductor substrate formed of a semiconductor material, a piezoelectric substrate formed of a piezoelectric material or the like is used as the object 1. As illustrated in FIG. 2, the line to cut 5 for cutting the object 1 is set in the object 1. The line to cut 5 is an imaginary line that extends linearly. When the modified region is formed inside the object 1, the laser light L is relatively moved along the line to cut 5 (that is, in a direction indicated by an arrow A in FIG. 2) in a state in which a converging point (a converging position) P is set inside the object 1, as illustrated in FIG. 3. That is, the stage 111 moves the support table 107 along a front surface 3 that is an incidence surface of the laser light L in the object 1 and relatively moves the converging point P of the laser light L along the line to cut 5 under the control of a stage control unit 115. Accordingly, as illustrated in FIGS. 4, 5, and 6, the modified region 7 is formed in the object 1 along the line to cut 5, and the modified region 7 formed along the line to cut 5 becomes a cutting starting point region 8.

The converging point P is a point on which the laser light L is converged. The line to cut 5 is not limited to a linear shape, and may have a curved shape, may be a three-dimensional shape in which these shapes are combined, or may have a coordinates-designated shape. The line to cut 5 is not limited to an imaginary line and may be a line actually drawn on the front surface 3 of the object 1. The modified region 7 may be continuously formed or may be intermittently formed. The modified region 7 may have rows or dots, and in short, the modified region 7 may be formed at least inside the object 1. Also, cracks from the modified region 7 may be formed, and the cracks and the modified region 7 may be exposed on an outer surface (the front surface 3, a back surface 21, or an outer peripheral surface) of the object 1. A laser light incidence surface when the modified region 7 is formed is not limited to the front surface 3 of the object 1 and may be the back surface of the object 1.

Incidentally, when the modified region 7 is formed inside the object 1, the laser light L is transmitted through the object 1 and is particularly absorbed near the converging point P located inside the object 1. Accordingly, the modified region 7 is formed in the object 1 (that is, an internal absorption type of laser processing). In this case, since the laser light L is hardly absorbed by the front surface 3 of the object 1, the front surface 3 of the object 1 is not melted. On the other hand, when the modified region 7 is formed on the front surface 3 of the object 1, the laser light L is particularly absorbed near the converging point P located on the front surface 3, there is melting and removal from the front surface 3, and removed portions such as holes or grooves are formed (a surface absorption type of laser processing).

The modified region 7 is a region in which a density, a refractive index, a mechanical strength, and other physical properties are different from those of the surroundings. Examples of the modified region 7 include a melt-processed region (at least one of a region which is once melted and then re-solidified, a region in a molten state and a region in a state of being re-solidified from the molten state), a cracked region, a dielectric breakdown region, and a region of which a refractive index has been changed. Examples of the modified region 7 also include a region in which such regions are mixed. Further, examples of the modified region 7 include a region in which a density of the modified region 7 has changed as compared with a density of a non-modified region in a material of the object 1, and a region in which lattice defects have formed. When the material of the object 1 is monocrystalline silicon, the modified region 7 can also be said to be a high dislocation density region.

A melt-processed region, a region in which a refractive index has changed, a region in which the density of the modified region 7 has changed as compared with the density of a non-modified region, and a region where lattice defects have been formed may further include crevices (cracks or microcracks) in the inside of these regions or at an interface between the modified region 7 and a non-modified region. An included cracks may extend over an entire surface of the modified region 7 or may be formed only in a part or in a plurality of parts thereof. The object 1 includes a substrate made of a crystal material having a crystal structure. For example, the object 1 includes a substrate formed of at least one of gallium nitride (GaN), silicon (Si), silicon carbide (SiC), LiTaO₃, and sapphire (Al₂O₃). In other words, the object 1 includes, for example, a gallium nitride substrate, a silicon substrate, a SiC substrate, a LiTaO₃ substrate, or a sapphire substrate. The crystal material may be an anisotropic crystal or an isotropic crystal. Further, the object 1 include a substrate made of an amorphous material having a non-crystalline structure (an amorphous structure), and include, for example, a glass substrate.

The modified region 7 can be formed by forming a plurality of modified spots (processing traces) along the line to cut 5. In this case, a plurality of modified spots are assembled and become the modified region 7. A modified spot is a modified part that is formed by a shot of one pulse of pulsed laser light (that is, laser irradiation of one pulse: laser shot). Examples of a modified spot include a crack spot, a melt-processed spot, a refractive index changed spot, and a spot which is a mixture of at least one of these. With respect to the modified spot, a size thereof or a length of a generated crack can be appropriately controlled in consideration of a required cutting accuracy, a required flatness of a cut surface, a thickness, type, a crystal orientation of the object 1, and the like. Further, in the embodiment, the modified spot can be formed as the modified region 7 along the line to cut 5.

Subsequently, the laser processing apparatus and the laser processing method according to this embodiment will be described. As illustrated in FIG. 1, the laser processing apparatus 100 includes a converging unit 108 and an actuator 110. The converging unit 108 includes the converging lens 105 and a housing 106. As described above, the converging lens 105 converges the laser light L on the object 1 supported by the support table 107. The housing 106 holds the converging lens 105. The laser light L output from the laser light source 101 is radiated onto the object 1 from the front surface 3 of the object 1 via the converging unit 108. Therefore, here, the front surface 3 of the object 1 is the incidence surface of the laser light L.

The actuator 110 is connected to the housing 106. In particular, the actuator 110 is thermally connected to the housing 106 by being connected to the housing 106 via, for example, a metal connection member (not illustrated). The actuator 110 drives the converging unit 108 in a direction crossing the front surface 3 of the object 1 (that is, a thickness direction of the object 1). That is, the actuator 110 drives the converging unit 108 to move the converging unit 108 closer to the front surface 3 or drives the converging unit 108 to move the converging unit 108 away from the front surface 3. Accordingly, a position (a converging position) of the converging point P of the laser light L with respect to the front surface 3 is adjusted. It should be noted that a driving scheme (a driving source) of the actuator 110 is, for example, a piezoelectric element, a stepping motor, an ultrasonic motor, a voice coil motor, a linear motor, an AC servo motor, a DC servo motor or a direct drive motor.

The laser processing apparatus 100 includes a temperature sensor 112 and a displacement sensor 114. The temperature sensor 112 is attached to the housing 106 and detects a temperature of the converging unit 108. In particular, the temperature sensor 112 is provided on an outer surface of the housing 106 and detects a temperature of the housing 106 as the temperature of the converging unit 108. It should be noted that the temperature sensor 112 may be attached to the actuator 110 thermally connected to the housing 106 instead of the housing 106, as will be described below.

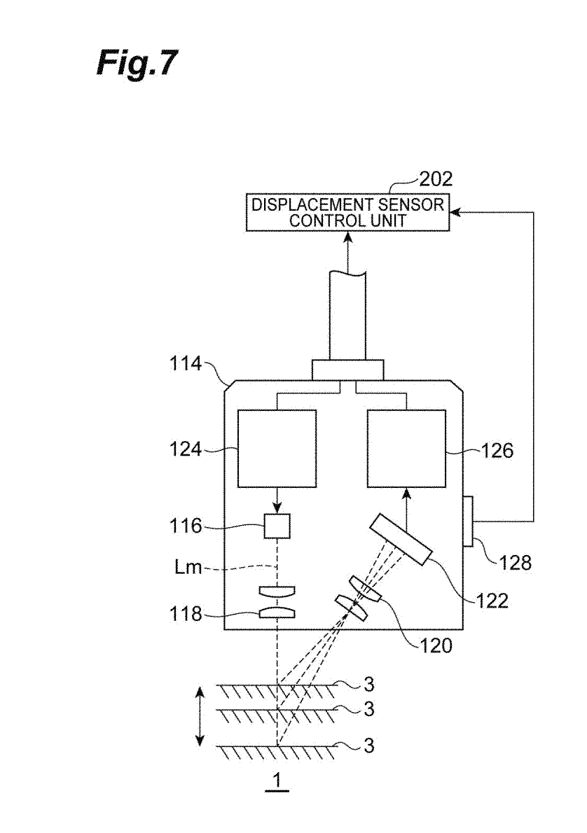

The displacement sensor 114 measures a displacement of the front surface 3 of the object 1 along the line to cut 5. The displacement sensor 114 is held integrally with the converging unit 108 to be movable relative to the object 1 along the line to cut 5. An example of the displacement sensor 114 will be described in detail. FIG. 7 is a schematic diagram illustrating an example of the displacement sensor. As illustrated in FIG. 7, the displacement sensor 114 is, for example, a laser displacement sensor using a triangulation scheme.

The displacement sensor 114 includes a measurement light source 116, a light projection lens 118, a light receiving lens 120, a light receiving element 122, a driving circuit 124, and a signal amplification circuit 126. The measurement light source 116 is, for example, a semiconductor laser. The measurement light source 116 is driven by the driving circuit 124 and outputs measurement laser light (measurement light) Lm. The light projection lens 118 focuses the measurement laser light Lm output from the measurement light source 116 on the front surface 3 of the object 1. The light receiving lens 120 converges the measurement laser light Lm reflected by the front surface 3 onto the light receiving element 122. The light receiving element 122 is, for example, an optical position detection element (PSD: Position Sensitive Detector). The light receiving element 122 receives the measurement laser light Lm via the light receiving lens 120 and generates an electrical signal. The signal amplification circuit 126 amplifies an electrical signal from the light receiving element 122 and outputs the amplified electrical signal to the outside.

In the displacement sensor 114, the measurement laser light Lm output from the measurement light source 116 is reflected by the front surface 3 of the object 1 and then forms a spot on the light receiving element 122 via the light receiving lens. When the front surface 3 of the object 1 is displaced, a reflection position of the measurement laser light Lm varies, and as a result, a position of the spot on the light receiving element 122 varies. The light receiving element 122 generates an electrical signal corresponding to the position of the spot of the measurement laser light Lm. Accordingly, the displacement sensor 114 measures the displacement of the front surface 3. That is, in the displacement sensor 114, the displacement of the front surface 3 along the line to cut 5 is measured by irradiating (scanning) the front surface 3 with the measurement laser light Lm along the line to cut 5.

It should be noted that the displacement sensor 114 further includes a temperature sensor 128. The temperature sensor 128 detects a temperature of the displacement sensor 114. For example, the temperature sensor 128 detects a temperature of the housing that accommodates each part of the displacement sensor 114. The temperature of the displacement sensor 114 changes due to heat generated in electronic circuits such as the driving circuit 124 or the signal amplification circuit 126, for example. Therefore, the temperature of the displacement sensor 114 becomes substantially constant with elapse of time according to the amount of heat generated in the electronic circuits.

In addition, the displacement sensor 114 is configured separately from the converging unit 108. Therefore, the displacement sensor 114 makes the measurement laser light Lm be incident on the front surface 3 of the object 1 on an optical path different from an optical path of the laser light L for processing. Therefore, the temperature of the displacement sensor 114 does not vary under an influence of the laser light L.

The description of the laser processing apparatus 100 will be continued with reference to FIG. 1. The laser processing apparatus 100 includes a converging position control unit (a control unit) 200. The converging position control unit 200 controls the driving of the converging unit 108 by the actuator 110 according to the amount of driving corresponding to the displacement of the front surface 3 of the object 1 measured by the displacement sensor 114. More specifically, the converging position control unit 200 calculates the amount of driving of the actuator 110 on the basis of the displacement of the front surface 3 of the object 1 measured by the displacement sensor 114 and the temperature of the converging unit 108 detected by the temperature sensor 112. The converging position control unit 200 controls driving of the converging unit 108 by the actuator 110 according to the calculated amount of driving.

To this end, the converging position control unit 200 includes a displacement sensor control unit 202, a correction unit 204, a driving control unit 206, and a data holding unit 208. The displacement sensor control unit 202 controls the displacement sensor 114. The displacement sensor control unit 202 receives an electrical signal from the light receiving element 122 via the signal amplification circuit 126. Accordingly, the displacement sensor control unit 202 acquires a result of the measurement of the displacement of the front surface 3 performed by the displacement sensor 114. Further, the displacement sensor control unit 202 acquires a detection result of the temperature of the displacement sensor 114 from the temperature sensor 128.

The correction unit 204 acquires a detection result of the temperature of the converging unit 108 from the temperature sensor 112. In addition, the correction unit 204 acquires measurement results of the displacement of the front surface 3 and a detection result of the temperature of the displacement sensor 114 from the displacement sensor control unit 202. The correction unit 204 calculates the amount of driving of the converging unit 108 by the actuator 110 on the basis of the displacement of the front surface 3 measured by the displacement sensor 114 and the temperature of the converging unit 108 detected by the temperature sensor 112. This point will be described in greater detail. It should be noted that the correction unit 204 may calculate the amount of driving of the converging unit 108 additionally in consideration of the temperature of the displacement sensor 114.

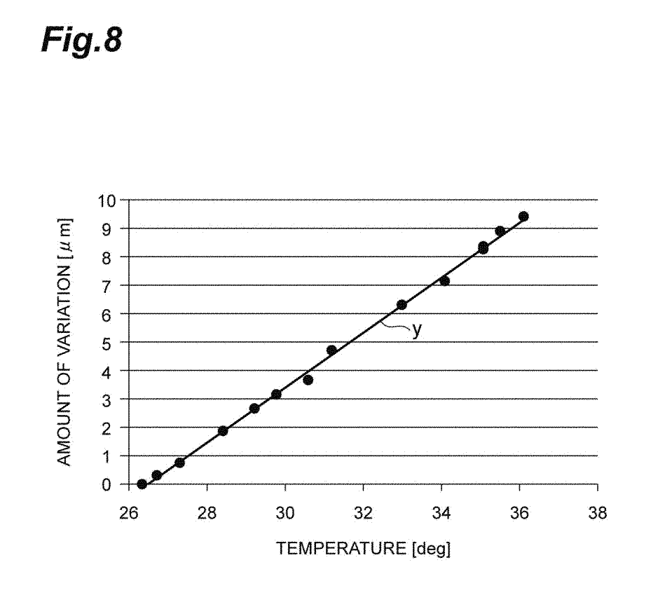

The correction unit 204 refers to the data held in the data holding unit 208 when the amount of driving of the converging unit 108 in the actuator 110 is calculated. The data holding unit 208 holds amount-of-variation data indicating a relationship between the temperature of the converging unit 108 and the amount of variation in the focal position of the converging lens 105. FIG. 8 is a graph showing an example of the amount-of-variation data. A horizontal axis of the graph in FIG. 8 indicates the temperature of the converging unit 108, and a vertical axis indicates the amount of variation in the focal position of the converging lens 105. Here, the amount of variation in the focal position of the converging lens 105 is indicated relative to a time when the temperature of the converging unit 108 is 26.3° C. (a reference temperature).

As illustrated in the graph in FIG. 8, the focal position of the converging lens 105 varies with change in the temperature of the converging unit 108. In particular, the amount of variation in the focal position of the converging lens 105 increases as the temperature of the converging unit 108 increases. This is thought to be caused by the expansion of the housing 106 holding the converging lens 105 due to increase in the temperature of the converging unit 108. The temperature of the converging unit 108 increases as part of the energy of the laser light L is converted into heat inside the converging unit 108 when the object 1 is irradiated with the laser light L. Referring to the graph in FIG. 8, the amount of variation in the focal position of the converging lens 105 increases substantially along a straight line y with respect to increase in the temperature of the converging unit 108. The straight line y is, for example, a straight line represented by y=0.96x-25.44 (x is a temperature).

The correction unit 204 acquires the amount of variation in the focal position according to the temperature of the converging unit 108 detected by the temperature sensor 112 by referring to the amount-of-variation data. In the above example, when x (temperature) is 30° C., y (the amount of variation) can be acquired as 3.36 μm. The correction unit 204 calculates the amount of driving by correcting the displacement of the front surface 3 measured by the displacement sensor 114 on the basis of the acquired amount of variation. In the above example, the amount of driving is calculated by subtracting the amount of variation of 3.36 μm from the displacement of the front surface 3 measured by the displacement sensor 114. The reason why the amount of variation is subtracted from the front surface 3 is that the subtraction compensates for the position of the converging lens 105 being brought closer to the front surface 3 due to expansion of the housing 106 and the converging point P of the laser light L being at a deeper position from the front surface 3, as described above.

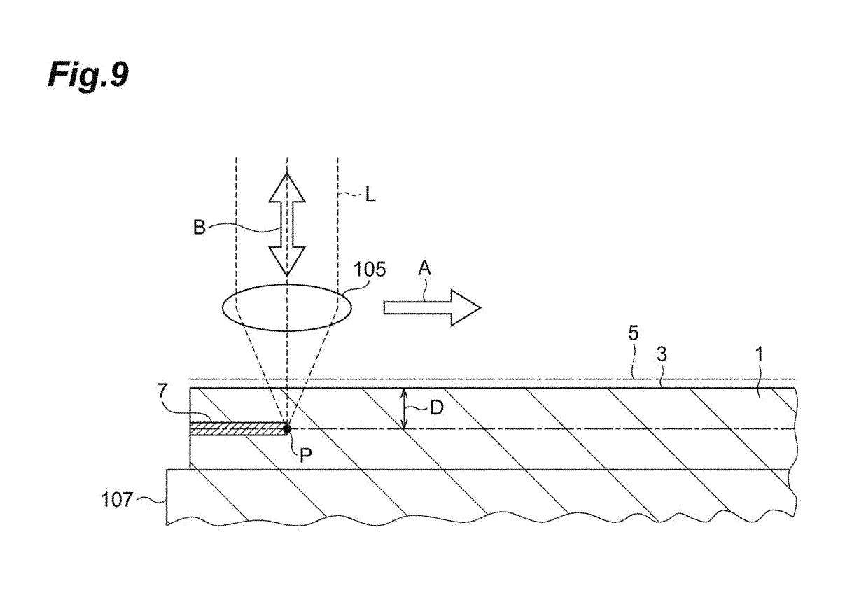

The driving control unit 206 acquires the amount of driving calculated as described above from the correction unit 204. As illustrated in FIG. 9, the driving control unit 206 controls the actuator 110 such that the actuator 110 drives the converging unit 108 (the converging lens 105) in a direction crossing the front surface 3 (a direction indicated by an arrow B in FIG. 9) according to the acquired amount of driving when the stage 111 moves the support table 107 to relatively move the converging point P in a direction along the front surface 3 (a direction indicated by an arrow A in FIG. 9) under the control of the stage control unit 115. Accordingly, the depth D (the position of the converging point P with respect to the front surface 3) of the converging point P from the front surface 3 is made constant regardless of the displacement of the front surface 3. That is, here, the modified region 7 is formed along the line to cut 5 at a predetermined position inside the object 1 from the front surface 3.

The converging position control unit 200 described above is mainly configured of a computer including, for example, a CPU, a ROM, a RAM, and the like. Each of the above units is realized by executing a predetermined program in the computer. Further, the converging position control unit 200 may be configured as the same computer as at least one of the laser light source control unit 102 and the stage control unit 115. Further, the converging position control unit 200 can exchange signals with at least the laser light source control unit 102 and the stage control unit 115 and perform the above operations in synchronization with the output of the laser light L and the movement of the support table 107.

Subsequently, the laser processing method according to the embodiment will be described. The laser processing method according to the embodiment is performed in the above laser processing apparatus 100. The laser processing method mainly includes a reference alignment step, a temperature detection step, an amount-of-variation acquisition step, a displacement measurement step, a calculation step, and a processing step. Here, for example, the displacement measurement step and the calculation step are performed successively as a series of operations together with the processing step after the reference alignment step, the temperature detection step, and the amount-of-variation acquisition step, or to be partially overlap each other. Details of each step will be described below.

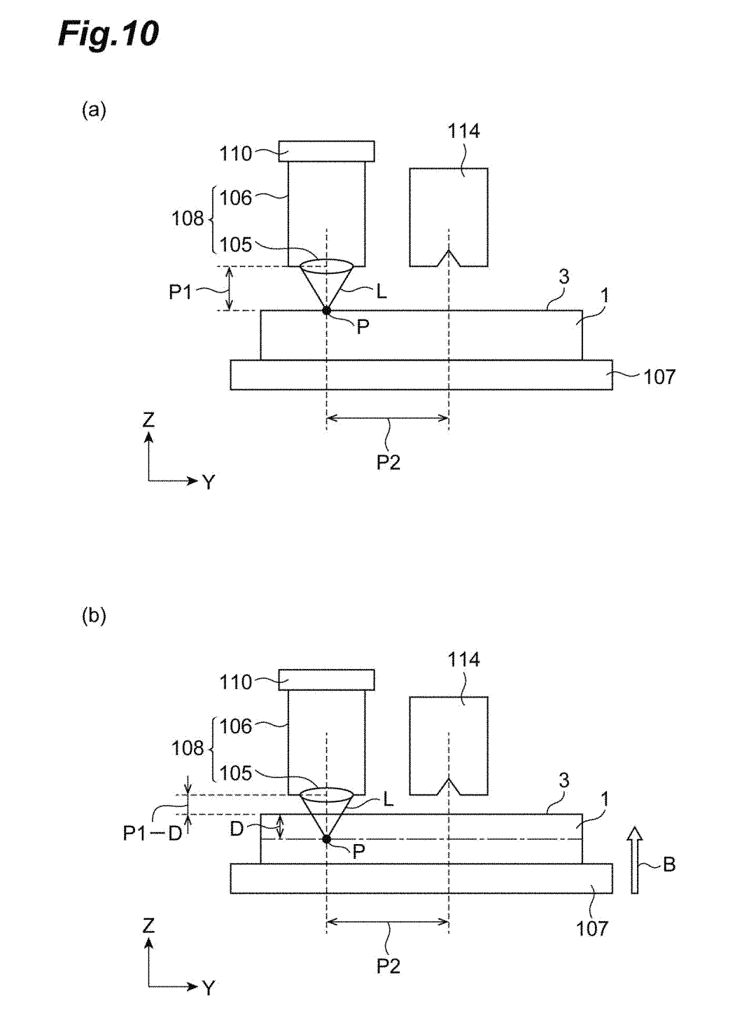

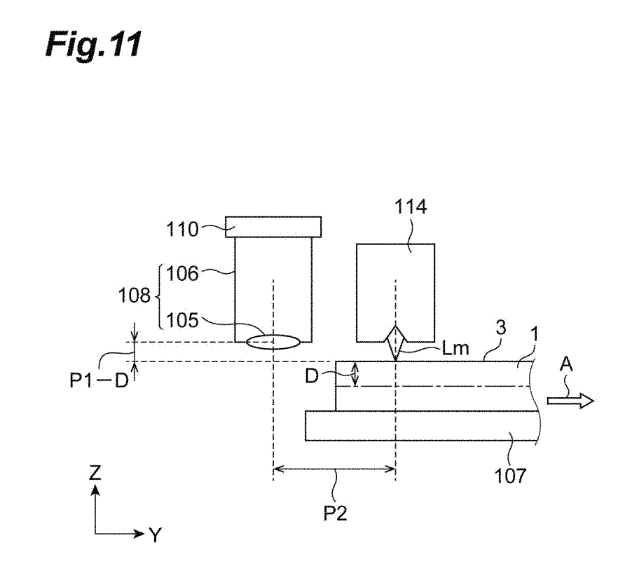

In the reference alignment step, the converging position control unit 200 determines a reference position of the converging lens 105 and a reference position of the displacement sensor in the direction crossing the front surface 3. In addition, the converging position control unit 200 stores the temperature T0 at this time. The reference alignment step will be described in detail. FIGS. 10 and 11 are views illustrating main steps of the laser processing method, and particularly illustrate reference alignment steps. As illustrated in (a) of FIG. 10, first, the reference position of the converging lens 105 is set in the reference alignment step. For example, here, the converging point P of the laser light L is set on the front surface 3 of the object 1, and a position in the Z direction (a direction crossing the front surface 3) of the converging lens 105 (for example, a distance P1 between the front surface 3 and the converging lens 105) at this time is set as a zero point of the converging lens 105. It should be noted that, as the laser light at this time, a laser light for processing having an intensity adjusted to be lower than a processing threshold value may be used or another laser light for observation may be used.

Subsequently, in the reference alignment step, the converging point P of the laser light L is set to be at a position at the depth D by relatively moving the object 1 toward the converging lens 105 in the Z direction (a direction indicated by an arrow B in (b) of FIG. 10) as illustrated in (b) of FIG. 10. Here, as the support table 107 is raised, the object 1 is moved relative to the converging lens 105. Accordingly, a distance between the converging lens 105 and the front surface 3 of the object 1 becomes distance P1-depth D. The depth D is one of processing positions at which the modified region 7 is formed.

Subsequently, in the reference alignment step, the reference position of the displacement sensor 114 is set, as illustrated in FIG. 11. For example, here, the object 1 is relatively moved in the Y direction (a direction indicated by an arrow B in FIG. 11) while the distance between the converging lens 105 and the front surface 3 is maintained as distance P1-depth D. A relative movement distance at this time is a distance P2 between the converging unit 108 and the displacement sensor 114. In addition, here, as the support table 107 moves toward the displacement sensor 114, the object 1 is moved relative to the displacement sensor 114. When the displacement sensor 114 radiates the measurement laser light Lm toward the front surface 3, the position of the displacement sensor 114 with respect to the front surface 3 in the Z direction is acquired as a zero point of the displacement sensor 114. Therefore, the converging lens 105 and the displacement sensor 114 have zero points at positions shifted by the depth D. At this time, the temperature T0, which is the reference temperature, is measured.

Subsequently, the temperature detection step is performed. In the temperature detection step, the temperature sensor 112 detects a temperature T1 of the converging unit 108 and transmits a detection result to the correction unit 204. The temperature T1 of the converging unit 108 detected here may be higher than the temperature T0 due to the irradiation with the laser light L at the time of forming the modified region 7 which has been already performed. Alternatively, the temperature T1 of the converging unit 108 detected here may be higher than the temperature T0 due to other factors other than irradiation with the laser light L.

Subsequently, the amount-of-variation acquisition step is executed. In the amount-of-variation acquisition step, the correction unit 204 acquires the amount of variation in the focal position of the converging lens 105 according to the temperature T1 of the converging unit 108 by referring to the amount-of-variation data held in the data holding unit 208. For example, when the temperature T0 of the converging unit 108 stored in the reference alignment step is the reference temperature and the temperature T1 of the converging unit 108 detected in the temperature acquisition step is 30° C., the amount of variation is acquired as 3.36 μm, as described above.

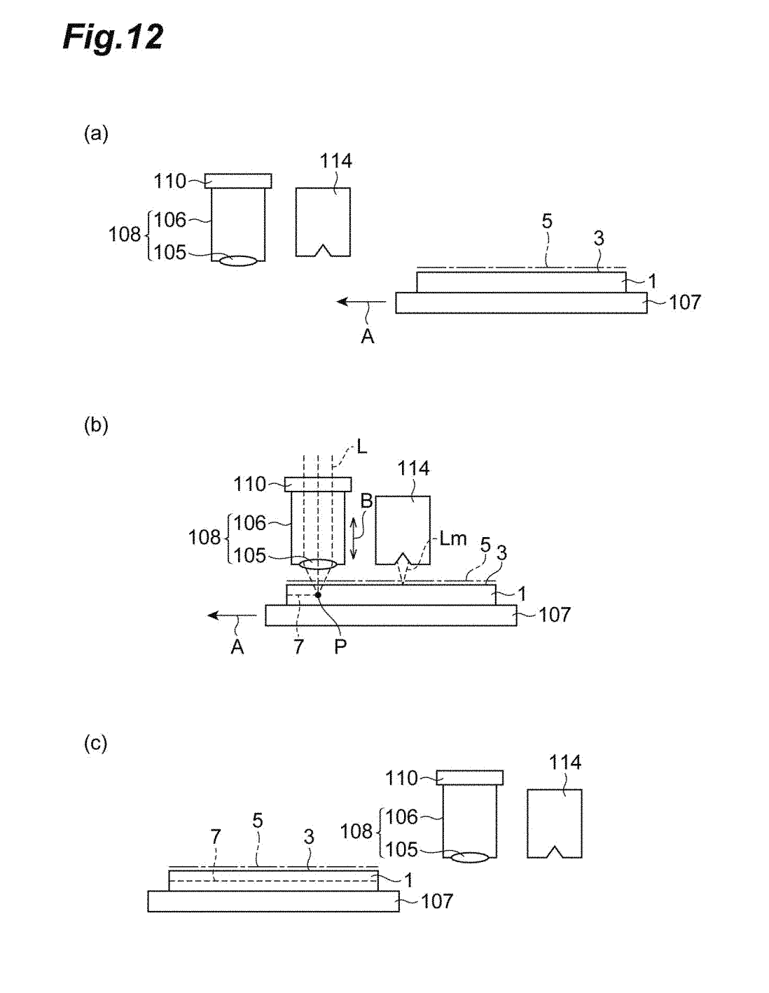

Subsequently, when the object 1 is irradiated with the laser light L under the control of the laser light source control unit 102, the stage control unit 115, and the converging position control unit 200, a processing step for forming the modified region 7 is performed. More specifically, in the processing step, first, as the stage control unit 115 moves the support table 107 as illustrated in (a) of FIG. 12, the object 1 is moved in a direction (a direction indicated by an arrow A in (a) of FIG. 12) toward the displacement sensor 114 and the converging unit 108. In this case, the object 1 first reaches the displacement sensor 114 and then reaches the converging unit 108 as seen from the direction crossing the front surface 3.

The displacement measurement step is started from a time when the object 1 reaches the displacement sensor 114. In the displacement measurement step, the displacement sensor 114 measures the displacement of the front surface 3 of the object 1 along the line to cut 5 under the control of the displacement sensor control unit 202. More specifically, as illustrated in (b) of FIG. 12, in the displacement measurement step, the displacement sensor 114 causes the measurement laser light Lm to be incident on the front surface 3 and detects reflected light of the measurement laser light Lm in a state in which the object 1 continues to move. Accordingly, the displacement of the front surface 3 is sequentially measured along the line to cut 5. The displacement sensor control unit 202 transmits measurement results to the correction unit 204.

Subsequently, the calculation step is performed. In the calculation step, the correction unit 204 calculates the amount of driving of the converging unit 108 in the direction crossing the front surface 3 on the basis of the displacement of the front surface 3 measured in the displacement measurement step and the temperature T1 of the converging unit 108 detected in the temperature detection step. More specifically, in the calculation step, the correction unit 204 corrects the displacement of the front surface 3 on the basis of the amount of variation according to the temperature T1 at the focal position of the converging lens 105 acquired in the amount-of-variation acquisition step, to thereby calculate the amount of driving. For example, the amount of driving is calculated by subtracting the amount of variation of 3.36 μm acquired in the amount-of-variation acquisition step from the displacement of the front surface 3 measured by the displacement sensor 114.

As illustrated in (b) and (c) of FIG. 12, in the continued processing step, the modified region 7 is formed by irradiating the object 1 with the laser light L while the driving control unit 206 is driving the converging unit 108 according to the amount of driving calculated as described above and while the stage control unit 115 is relatively moving the converging point P of the laser light L along the line to cut 5. Accordingly, the modified region 7 is formed along the line to cut 5 at a predetermined position (the depth D) inside the object 1 from the front surface 3. It should be noted that the temperature detection step, the amount-of-variation acquisition step, and the calculation step may be repeatedly performed while the processing step continues. In this case, as the temperature of the converging unit 108 changes from moment to moment due to the continuously output laser light L, it is possible to sequentially calculate the amount of driving suitable for a temperature change.

As described above, in the laser processing apparatus 100, it is possible to adjust the position of the converging point P of the laser light L from the front surface 3 by the actuator 110 driving the converging unit 108 in the direction crossing the front surface 3 (the incidence surface of the laser light L in the object 1). In particular, in the laser processing apparatus 100, the displacement sensor 114 measures the displacement of the front surface 3, and the temperature sensor 112 measures the temperature of the converging unit 108. The converging position control unit 200 calculates the amount of driving of the converging unit 108 that is performed by the actuator 110 on the basis of the displacement of the front surface 3 and the temperature of the converging unit 108.

In addition, when the converging point P of the laser light L is relatively moved (that is, when the laser light L is radiated), the converging position control unit 200 controls the actuator 110 such that the actuator 110 drives the converging unit 108 according to the amount of driving. Therefore, in the laser processing apparatus 100, it is possible to adjust the position of the converging point P of the laser light L from the front surface 3 in consideration of the temperature of the converging unit 108. Therefore, according to the laser processing apparatus 100, a formation position of the modified region 7 can be accurately controlled irrespective of the temperature of the converging unit 108.

This effect will be described in greater detail. In the laser processing apparatus 100, the correction unit 204 of the converging position control unit 200 acquires the amount of variation in the focal position according to the temperature of the converging unit 108 detected by the temperature sensor 112 by referring to the amount-of-variation data held in the data holding unit 208. Further, the correction unit 204 calculates the amount of driving of the actuator 110 by correcting the displacement of the front surface 3 measured by the displacement sensor 114 on the basis of the acquired amount of variation. The driving control unit 206 of the converging position control unit 200 controls the actuator 110 such that the actuator 110 drives the converging unit 108 according to the calculated amount of driving.

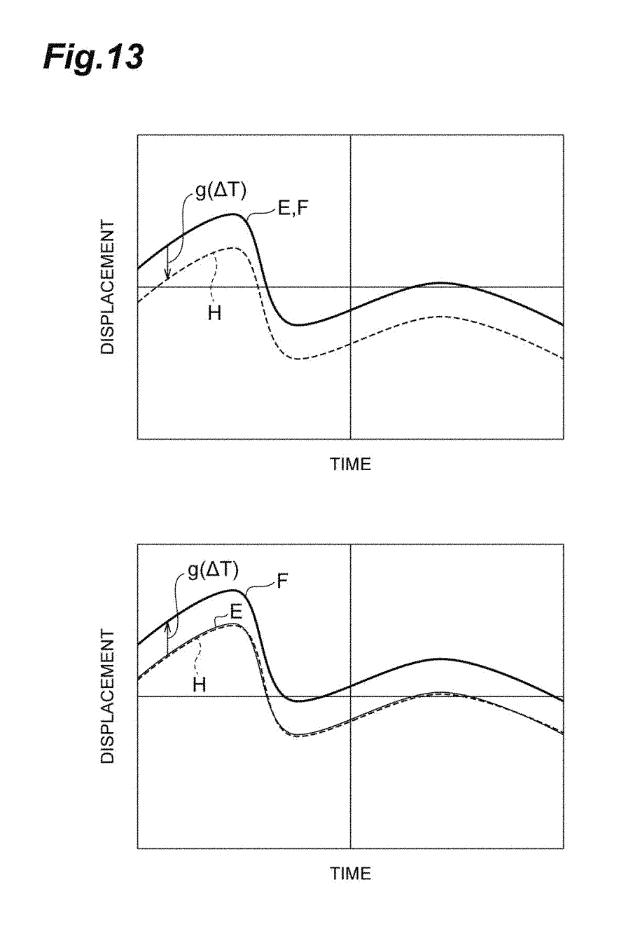

FIG. 13 is a diagram illustrating the correction of displacement of the front surface. In a graph illustrated in FIG. 13, a horizontal axis indicates time and a vertical axis indicates the displacement. The time on the horizontal axis indicates an elapsed time since the displacement sensor 114 has started measuring the displacement of the front surface 3. The displacement sensor 114 measures the displacement of the front surface 3 by scanning the relatively moved object to be processed 1 with the measurement laser light Lm. Therefore, the time on the horizontal axis is the same as a position on the front surface 3. Further, the displacement on the vertical axis indicates a position in the thickness direction of the object 1 from a reference position (for example, an average position) of the front surface 3.

As illustrated in (a) of FIG. 13, a displacement E of the front surface 3 measured by the displacement sensor 114 matches the amount of driving F of the actuator 110 in a state in which the correction is not performed by the correction unit 204. That is, the displacement E of the front surface 3 is used as it is, as the amount of driving F of the actuator 110. As a result, when the focal position of the converging lens 105 varies according to a temperature change (ΔT=T1−T0) of the converging unit 108, a displacement H of the position (depth) of the converging point P of the laser light L deviates from the displacement E of the front surface 3 by the amount of variation g(ΔT).

On the other hand, as illustrated in (b) of FIG. 13, the displacement H of the position (depth) of the converging point P of the laser light L can be prevented from deviating from the displacement E of the front surface 3 by correcting the amount of driving F of the actuator 110 by the amount of variation g(ΔT) using the correction unit 204. Therefore, according to the laser processing apparatus 100, the formation position of the modified region 7 with respect to the front surface 3 can be accurately controlled regardless of the temperature of the converging unit 108. For the same reason, the formation position of the modified region 7 can be accurately controlled using the laser processing method that is performed in the laser processing apparatus 100. It should be noted that, although not illustrated in FIG. 13, the amount of driving F of the actuator 110 (the driving signal of the actuator 110) and the displacement H of the position of the converging point P are actually delayed from the displacement E of the front surface 3 measured by the displacement sensor 114 (a measurement signal of the displacement sensor 114). A delay time is (distance P2 between the converging unit 108 and the displacement sensor 114)/(relative moving speed (processing speed) of the object 1).

Here, in the laser processing apparatus 100, the displacement sensor 114 causes the measurement laser light Lm to be incident on the front surface 3 in an optical path different from the optical path of the laser light L. Thus, when the optical path of the laser light L is different from the optical path of the measurement laser light Lm, a state of radiation (for example, the converging position) of the measurement laser light Lm onto the front surface 3 is independent of the variation in the focal position of the converging lens 105 due to a change in temperature of the converging unit 108. Therefore, as described above, it is particularly important to adjust the position of the converging point P of the laser light L in consideration of the temperature of the converging unit 108. This is caused by the following reason.

That is, if the front surface 3 is irradiated with the measurement laser light Lm on an optical path overlapping the optical path of the laser light L, the converging lens 105 is also interposed in the optical path of the measurement laser light Lm. Therefore, in this case, a variation in the focal position of the converging lens 105 due to change in the temperature of the converging unit 108 acts on the measurement laser light Lm as in the laser light L. Therefore, in this case, when the position of the converging point P of the laser light L is adjusted on the basis of the displacement of the front surface 3 measured by the measurement laser light Lm, the necessity for taking the temperature of the converging unit 108 into consideration is relatively small.

On the other hand, as described above, when the measurement laser light Lm is incident on the front surface 3 in the optical path different from the optical path of the laser light L, the converging lens 105 is not interposed in the optical path of the measurement laser light Lm. Therefore, in this case, variation in the focal position of the converging lens 105 due to change in the temperature of the converging unit 108 acts only on the laser light L and does not act on the measurement laser light Lm. Therefore, in this case, when the position of the converging point P of the laser light L is adjusted on the basis of the displacement of the front surface 3 measured using the measurement laser light Lm, it is important to consider the temperature of the converging unit 108.

Further, in the laser processing apparatus 100, the converging unit 108 includes a housing 106 that holds the converging lens 105, and the temperature sensor 112 detects the temperature of the housing 106 as the temperature of the converging unit 108. As described above, the variation in the focal position of the converging lens 105 greatly depends on change in the temperature of the housing 106 holding the converging lens 105. That is, the focal position of the converging lens 105 greatly varies due to expansion or contraction due to change in the temperature of the housing 106. Therefore, it is possible to more accurately control the formation position of the modified region 7 by detecting the temperature of the housing 106 and using the temperature for calculation of the amount of driving.

The embodiments of the laser processing apparatus and the laser processing method according to an aspect of the present invention have been described above. Accordingly, the laser processing apparatus and the laser processing method according to an aspect of the present invention are not limited to those described above. The laser processing apparatus and the laser processing method according to an aspect of the present invention can be obtained by arbitrarily modifying the above-described apparatus and method within a scope not changing the gist of the respective claims.

For example, in the above-described embodiment, the converging point P of the laser light L is relatively moved by moving the support table 107. However, the converging point P of the laser light L may be relatively moved by moving the converging unit 108 (and the laser light source 101), or the converging point P of the laser light L may be relatively moved by moving both the support table 107 and the converging unit 108.

Further, as described above, the temperature sensor 112 may be attached to the actuator 110. In this case, the temperature sensor 112 can detect the temperature of the actuator 110 as the temperature of the converging unit 108. This is because the actuator 110 is thermally connected to the housing 106, and therefore, the temperature of the actuator 110 changes corresponding to change in the temperature of the converging unit 108. In this case, the position of the converging point P of the laser light L can be controlled more accurately by detecting the temperature of the actuator 110 connected to the housing 106 and using the temperature for calculation of the amount of driving, as in the case described above. In particular, in this case, there is no problem with layering of wirings of the temperature sensor 112 when the converging unit 108 is handled (for example, detached). It should be noted that the temperature sensor 112 is not limited to the actuator 110, and a temperature of any part of which a temperature changes in correspondence to change in the temperature of the converging unit 108 can be detected as the temperature of the converging unit 108.

Further, in the embodiment, a triangulation scheme has been illustrated as a scheme for measuring the displacement in the displacement sensor 114. However, the scheme for measuring the displacement in the displacement sensor 114 may be another scheme such as a laser confocal scheme or a spectral interference scheme.

In the case of a laser confocal scheme, the displacement sensor 114 can be a laser focus displacement meter. In a laser focus displacement meter, measurement laser light output from a measurement light source such as a semiconductor laser passes through a half mirror and an objective lens to form a spot on an object to be processed. The measurement laser light reflected by the object reaches the half mirror again and is reflected at a right angle by the half mirror. The measurement laser light reflected by the half mirror is converged on one point at a position of a pinhole, passes through the pinhole, and reaches the light receiving element.

When a distance from the measurement light source to the object varies, the measurement laser light reflected by the object and the half mirror is not converged at the position of the pinhole and is blurred, and therefore, it is difficult for the measurement laser light to pass through the pinhole and to be detected as a light receiving signal in the light receiving element. On the basis of this principle, the laser focus displacement meter measures the displacement of the front surface of an object to be processed. That is, the laser focus displacement meter mechanically moves the objective lens using a tuning fork or the like to thereby detect a position of the objective lens at which the measurement laser light passes through the pinhole and measure the distance to the object.

Thus, when the laser focus displacement meter is used as the displacement sensor 114, it is possible to exclude color, slopes, and roughness of the object, and an influence of penetration light on the object and measure the displacement of the front surface of the object, in contrast to a case in which the displacement is measured on the basis of the amount or the angle of the reflected light of the measurement laser light.

Furthermore, in the case of the spectral interference scheme, the displacement sensor 114 can be a spectroscopic interference laser displacement meter. In a spectroscopic interference laser displacement meter, for example, measurement light in a wide wavelength range output from a measurement light source such as an SLD is partially reflected on a reference surface inside a sensor head and the rest is transmitted through the reference surface. The measurement light transmitted through the reference surface is regularly reflected by an object to be processed and returns to the inside of the sensor head. The measurement light reflected by the reference surface and the measurement light reflected by the object interfere with each other. The intensity of the interference at each wavelength of the measurement light is determined by a distance from the reference surface to the object and is a maximum when the distance is an integer multiple of each wavelength. Therefore, an intensity distribution with respect to wavelength can be obtained by separating the interference light into each of wavelengths using a spectroscope. The distance to the object is calculated by performing waveform analysis on the intensity distribution with respect to the wavelength.

Further, in the above embodiment, the laser processing apparatus 100 performs internal processing of the object 1 such as the formation of the modified region 7. However, the laser processing apparatus 100 can also be used for surface processing of the object 1 such as ablation. That is, the laser processing apparatus 100 can be used for any laser processing irrespective of whether it is on the inside or on the front surface of the object 1. Therefore, the effects regarding the formation of the modified region 7 as described above may be generalized as follows.

That is, in the laser processing apparatus 100 and the laser processing method thereof, it is possible to adjust the position of the converging point P of the laser light L with respect to the incidence surface by driving the converging unit 108 in the direction crossing the incidence surface of the laser light L (for example, the front surface 3 of the object 1). In particular, in the laser processing apparatus 100 and the laser processing method thereof, the displacement of the incidence surface is measured along the line to process and the temperature of the converging unit 108 is measured. The amount of driving of the converging unit 108 is calculated on the basis of both the displacement of the incidence surface and the temperature of the converging unit 108. In addition, when the converging point P of the laser light L is relatively moved (that is, when the laser light L is radiated), the converging unit 108 is driven according to the amount of driving. Therefore, in the laser processing apparatus 100 and the laser processing method thereof, it is possible to adjust the position of the converging point P of the laser light L with respect to the incidence surface in consideration of the temperature of the converging unit 108. That is, the position of the converging point P of the laser light L can be accurately controlled regardless of the temperature of the converging unit 108. Accordingly, degradation in accuracy of laser processing is curbed.

Further, the laser processing apparatus 100 and the laser processing method thereof are not limited to an aspect in which the converging unit 108 is driven by the actuator 110 when the position of the converging point P of the laser light L in the direction crossing the front surface 3 is adjusted. That is, the laser processing apparatus 100 can include an adjustment unit (not illustrated) that adjusts the position of the converging point P in the direction crossing the front surface (the incidence surface) 3 instead of the actuator 110. In this case, the converging position control unit (the control unit) 200 calculates the amount of adjustment in the adjustment unit on the basis of the displacement of the front surface 3 measured by the displacement sensor 114 and the temperature of the converging unit 108 detected by the temperature sensor 112, and controls the adjustment unit such that the adjustment unit adjusts the position of the converging point P according to the amount of adjustment when the stage control unit (the moving section) 115 relatively moves the converging point P.

More specifically, the converging position control unit 200 includes the data holding unit 208 that holds amount-of-variation data indicating a relationship between the temperature of the converging unit 108 and the amount of variation in a focal position of the converging lens 105, the correction unit 204 that acquires the amount of variation in the focal position according to the temperature of the converging unit 108 detected by the temperature sensor 112 by referring to the amount-of-variation data, and corrects the displacement of the front surface 3 measured by the displacement sensor 114 on the basis of the amount of variation to thereby calculate the amount of adjustment, and a driving control unit (not illustrated) that controls the adjustment unit such that the converging unit 108 is driven according to the amount of adjustment.

Further, in the calculation step, the correction unit 204 calculates the amount of adjustment of the position of the converging point P of the laser light L in the direction crossing the front surface 3 on the basis of the displacement of the front surface 3 measured in the displacement measurement step and the temperature T1 of the converging unit 108 detected in the temperature detection step. More specifically, in the calculation step, the correction unit 204 corrects the displacement of the front surface 3 to thereby calculate the amount of adjustment on the basis of the amount of variation according to the temperature T1 at the focal position of the converging lens 105 acquired in the amount-of-variation acquisition step. In the processing step, the modified region 7 is formed (laser processing is performed) by irradiating the object 1 with the laser light L while adjusting the position of the converging point P according to the amount of adjustment calculated as described above and while the stage control unit 115 is relatively moving the converging point P of the laser light L along the line to cut 5.

It should be noted that the inventor has obtained the following knowledge regarding adjusting the position of the converging point P using a device other than the actuator 110. That is, there is a trade-off relationship between a stroke and a speed of the converging lens 105 in a case where the converging lens 105 is directly driven in adjusting the position of the converging point P. When the position of the converging point P is to be changed at a higher speed, a method of putting an optical system that changes a divergence angle of incident light, in front of the converging lens 105 is conceivable. Further, for example, when an element that operates to change a power of a lens by applying a voltage to an optical crystal is used, a method of driving some of a plurality of lenses is conceivable. It is possible to make the position of the converging point P variable by changing a combined focal length of these lenses and the converging lens 105.

It should be noted that it is thought that, when a spatial light modulator is interposed in front of the converging lens 105, a 4f optical system for changing a converging point is newly provided, for example, between a beam expander and the spatial light modulator, and configured to change a divergence angle corresponding to the spatial light modulator by changing an interval between lenses of the optical system, such that the position of the converging point P can be changed. In this case, it is only necessary to move one of the lenses of the newly provided 4f optical system, and therefore, it is conceivable that high speed operation can be performed. Furthermore, when the spatial light modulator is not used, the same configuration may be disposed at any position.

### INDUSTRIAL APPLICABILITY

It is possible to provide a laser processing apparatus and a laser processing method in which degradation in accuracy of laser processing is curbed.

### REFERENCE SIGNS LIST

1 Object to be processed
3 Surface (incidence surface)
5 Line to cut (line to process)
7 Modified region
100 Laser processing apparatus
101 Laser light source
105 Converging lens
106 Housing
107 Support table
108 Converging unit
111 Stage (moving unit)
112 Temperature sensor
114 Displacement sensor
115 Stage control unit (moving unit)
200 Converging position control unit (control unit)
204 Correction unit
206 Driving control unit
208 Data holding unit
L Laser light
Lm Measurement laser light (measurement light)
P Converging point

1: A laser processing apparatus that performs laser processing on an object to be processed by irradiating the object with laser light along a line to process, the laser processing apparatus comprising:
a support table that supports the object;
a laser light source that outputs the laser light;
a converging unit including a converging lens for converging the laser light on the object supported by the support table;
a moving unit that moves at least one of the support table and the converging unit along an incidence surface of the laser light in the object and relatively moves a converging point of the laser light along the line to process;
an actuator for driving the converging unit in a direction crossing the incidence surface;
a displacement sensor that measures a displacement of the incidence surface along the line to process;
a temperature sensor that detects a temperature of the converging unit; and
a control unit that calculates the amount of driving of the converging unit by the actuator on the basis of the displacement of the incidence surface measured by the displacement sensor and the temperature of the converging unit detected by the temperature sensor, and controls the actuator such that the converging unit is driven according to the amount of driving when the moving unit relatively moves the converging point.

2: The laser processing apparatus according to claim 1,
wherein the control unit comprises
a data holding unit that holds amount-of-variation data indicating a relationship between the temperature of the converging unit and the amount of variation in a focal position of the converging lens;
a correction unit that acquires the amount of variation in the focal position according to the temperature of the converging unit detected by the temperature sensor by referring to the amount-of-variation data, and corrects the displacement of the incidence surface measured by the displacement sensor on the basis of the amount of variation to thereby calculate the amount of driving; and
a driving control unit that controls the actuator such that the converging unit is driven according to the amount of driving.

3: The laser processing apparatus according to claim 1, wherein the displacement sensor measures the displacement of the incidence surface by making measurement light be incident on the incidence surface in an optical path different from an optical path of the laser light and detecting reflected light of the measurement light.

4: The laser processing apparatus according to claim 1,
wherein the converging unit includes a housing that holds the converging lens, and
the temperature sensor is attached to the housing and detects a temperature of the housing as the temperature of the converging unit.

5: The laser processing apparatus according to claim 1,
wherein the converging unit includes a housing that holds the converging lens,
the actuator is connected to the housing, and
the temperature sensor is attached to the actuator and detects a temperature of the actuator as the temperature of the converging unit.

6: A laser processing method for performing laser processing on an object to be processed by irradiating the object with laser light along a line to process, the laser processing method comprising:
a temperature detection step of detecting a temperature of a converging unit including a converging lens for converging the laser light on the object;
a displacement measurement step of measuring a displacement of an incidence surface of the laser light in the object along the line to process;
a calculation step of calculating the amount of driving of the converging unit in a direction crossing the incidence surface on the basis of the displacement of the incidence surface measured in the displacement measurement step and the temperature of the converging unit detected in the temperature detection step; and
a processing step of performing the laser processing by irradiating the object with the laser light while driving the converging unit according to the amount of driving and while relatively moving a converging point of the laser light along the line to process.

7: A laser processing apparatus that performs laser processing on an object to be processed by irradiating the object with laser light along a line to process, the laser processing apparatus comprising:
a support table that supports the object;
a laser light source that outputs the laser light;
a converging unit including a converging lens for converging the laser light on the object supported by the support table;
a moving unit that moves at least one of the support table and the converging unit along an incidence surface of the laser light in the object and relatively moves a converging point of the laser light along the line to process;
an adjustment unit that adjusts a position of the converging point in a direction crossing the incidence surface;
a displacement sensor that measures a displacement of the incidence surface along the line to process;
a temperature sensor that detects a temperature of the converging unit; and
a control unit that calculates the amount of adjustment in the adjustment unit on the basis of the displacement of the incidence surface measured by the displacement sensor and the temperature of the converging unit detected by the temperature sensor, and controls the adjustment unit such that the adjustment unit adjusts the position of the converging point according to the amount of adjustment when the moving unit relatively moves the converging point.

8: The laser processing apparatus according to claim 7,
wherein the control unit comprises
a data holding unit that holds amount-of-variation data indicating a relationship between the temperature of the converging unit and the amount of variation in a focal position of the converging lens;
a correction unit that acquires the amount of variation in the focal position according to the temperature of the converging unit detected by the temperature sensor by referring to the amount-of-variation data, and corrects the displacement of the incidence surface measured by the displacement sensor on the basis of the amount of variation to thereby calculate the amount of adjustment; and
an adjustment control unit that controls the adjustment unit such that the adjustment unit adjusts the position of the converging point according to the amount of adjustment.

9: The laser processing apparatus according to claim 7, wherein the displacement sensor measures the displacement of the incidence surface by making measurement light be incident on the incidence surface in an optical path different from an optical path of the laser light and detecting reflected light of the measurement light.

10: The laser processing apparatus according to claim 7,
wherein the converging unit includes a housing that holds the converging lens, and
the temperature sensor is attached to the housing and detects a temperature of the housing as the temperature of the converging unit.

11: A laser processing method for performing laser processing on an object to be processed by irradiating the object with laser light along a line to process, the laser processing method comprising:
a temperature detection step of detecting a temperature of a converging unit including a converging lens for converging the laser light on the object;
a displacement measurement step of measuring a displacement of an incidence surface of the laser light in the object along the line to process;
a calculation step of calculating the amount of adjustment of a position of a converging point of the laser light in a direction crossing the incidence surface on the basis of the displacement of the incidence surface measured in the displacement measurement step and the temperature of the converging unit detected in the temperature detection step; and
a processing step of performing the laser processing by irradiating the object with the laser light while adjusting the position of the converging point according to the amount of adjustment and while relatively moving the converging point along the line to process.
